(19) United States
(12) Patent Application Publication
(10) Pub. No.: US 2019/0045292 A1
(43) Pub. Date: Feb. 7, 2019

(54) EXTENDING BATTERY LIFE IN HEADPHONES VIA ACOUSTIC IDLE DETECTION

(71) Applicant: Intel Corporation, Santa Clara, CA (US)

(72) Inventors: Weng-Chin Yung, Folsom, CA (US); Adeel Aslam, Folsom, CA (US)

(73) Assignee: Intel Corporation, Santa Clara, CA (US)

(21) Appl. No.: 15/981,692

(22) Filed: May 16, 2018

(51) Int. Cl. H04R 1/10

(52) U.S. Cl. CPC H04R 1/1041; H04R 2460/01; H04R 2460/03

(57) ABSTRACT

An acoustic system, apparatus, method, and computer readable medium may provide for technology to automatically detect idleness in headphones. The technology may include a comparator to receive a first acoustic signal from a first earpiece of the headphones and a second acoustic signal from a second earpiece of the headphones and to compare the first and second signals. The technology may further include a processor coupled to the network interface circuitry and one or more memory devices coupled to the processor. The one or more memory devices may include instructions, which when executed by the processor, cause the headphones to determine if the first and second acoustic signals match within a pre-determined threshold, and to signal the power management logic of the headphones to power-down the headphones if the signals match.

### TECHNICAL FIELD

Embodiments generally relate to headphone technology. More particularly, embodiments relate to extending battery life in headphones via acoustic idle detection.

### BACKGROUND

Headphones with built-in active noise cancellation have made a sweeping change to the content consumption experience such that it may be a must-have accessory for more than just audiophiles. When paired with wireless connectivity, users may be able to use them anywhere they want for their listening pleasure, making phone calls, or to enjoy some peace and quiet. Like many electronic gadgets, however, these devices may be powered by a battery, even when wired. No one appreciates their listening experiences or quiet enjoyment being disturbed because the batteries need to be changed or recharged. Indeed, there may be occasions when a user forgets to turn the headphone devices off when not in use, thereby resulting in the battery power being drained more quickly.

One solution may be to automatically turn the power off when wireless (e.g., Bluetooth) headphones are not being used for a period of time such as, for example, five (5) minutes. Such idleness may be detected by checking whether the headphones are paired and/or connected with an audio source. While such a solution may work for wireless headphones, it typically does not work for non-digital wired headphones. In addition, even if a wireless headphone is paired and/or connected with an audio source, there may still be scenarios where a user may forget to stop the source when the headphones are not in use.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of example scenarios in which headphones of a user remain powered on after being removed from the head of the user thereby causing the user angst when finding the headphone battery dead;

FIG. 2 is an illustration of example scenarios in which headphones left powered-on by a user are auto-powered down using acoustic detection techniques thereby causing user delight when the user finds the headphone battery still charged according to an embodiment;

FIG. 3 is a block diagram illustrating an example acoustic processing pipeline of a headphone left earpiece that determines whether the user is wearing the headphones according to an embodiment;

FIG. 4 is a block diagram illustrating an example acoustic processing pipeline of a headphone right earpiece that determines whether the user is wearing the headphones according to an embodiment;

FIG. 5A is a flow diagram of an example of a simplified method of managing the on/off state of headphones using acoustic idle detection of whether the headphones are being worn according to an embodiment;

FIG. 5B is a flow diagram of an example of a method of using acoustic detection techniques to determine if a user is wearing headphones according to an embodiment;

FIG. 6 is a block diagram of an example of an acoustic idle detection headphone system to extend battery life of headphones according to an embodiment;

FIG. 7 is an illustration of an example of a semiconductor package apparatus according to an embodiment; and

FIG. 8 is a block diagram of an exemplary processor according to an embodiment.

### DESCRIPTION OF EMBODIMENTS

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Technology to extend the battery life of headphones left unattended for a period of time while powered-on is described herein. Embodiments use acoustic idle techniques to determine whether the headphones should be powered-down. When the headphones are left in the on state, but are not worn on the ears, each earpiece may listen for the content of the other earpiece due to their physical adjacency and determine if the signal is above a certain threshold that indicates the user's ears and head are not blocking the content. If an audio source is still playing through the earpieces, the headphone may be able to recognize this by comparing the captured audio against its knowledge of what is being rendered to the other earpiece. If an audio source is not available or detected, a chirp pattern, such as, for example, an ultrasonic waveform, may be transmitted from one earpiece in order for the other earpiece to receive it. In both cases, the headphones “eavesdrop” the nearby sounds, and using the captured audio, determine if the device is idle. Based on the length of time the headphones have been idle, a decision may be made to safely shut-off power to the headphones. Embodiments allow for the replacement of a physical on/off switch with a stateless button that is controllable manually and via software. Stateless buttons are well known in the relevant art(s).

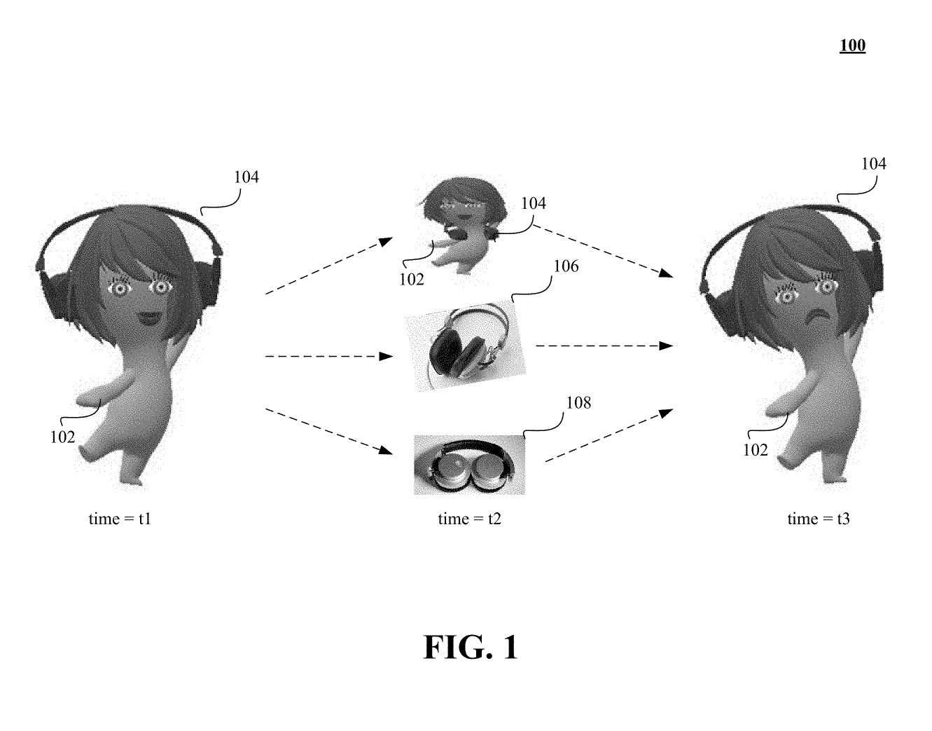

FIG. 1 depicts scenarios where headphones of a user remain powered on after being removed from the head of the user thereby causing the user angst when finding the headphone battery dead. As shown in FIG. 1, at time t1 a user 102 is wearing headphones 104. The user 102 may be listening to an audio source or may be using the headphones 104 for active noise cancellation. The user 102 may keep the headphones 104 on for several hours. Sometime later (i.e., at time t2), the user 102 may take the headphones 104 off. For example, the user 102 may place the headphones 104 around the neck of the user 102 with the headphones 104 still powered on as shown at time t2. Alternatively, instead of resting the headphones 104 around the neck of the user 102, the user 102 may take the headphones 104 from her ears while actively streaming content or actively cancelling noise and place the headphones 104 on a flat surface. The flat surface may be any flat surface, such as, for example, a table, a desk, a counter, etc. Two ways in which the earpieces of the headphones 104 may be positioned when placed on the flat surface are shown at time t2.

For example, the headphones 104 may be placed such that both earpieces are collapsed together (106). In another example, the headphones 104 may be placed such that both earpieces are coupled against each other in close proximity, with each earpiece facing the same direction (108). In any one of the three positions of the headphones 104 shown at time t2, the user 102 has forgotten to turn the power off. Thus, allowing the headphones 104 to remain powered-on for long periods of time, resulting in reduced battery life. Approximately 4 hours later, at time t3, the user 102 decides to listen to some music, make phone calls, or enjoy peace and quiet using her headphones 104. When the user 102 places the headphones 104 over her ears, the user 102 is dismayed because the batteries in the headphones 104 are drained, as shown at time t3 by the frown upon her face. The user 102 can no longer listen to music, make phone calls, or enjoy peace and quiet using her headphones 104 without re-charging the batteries.

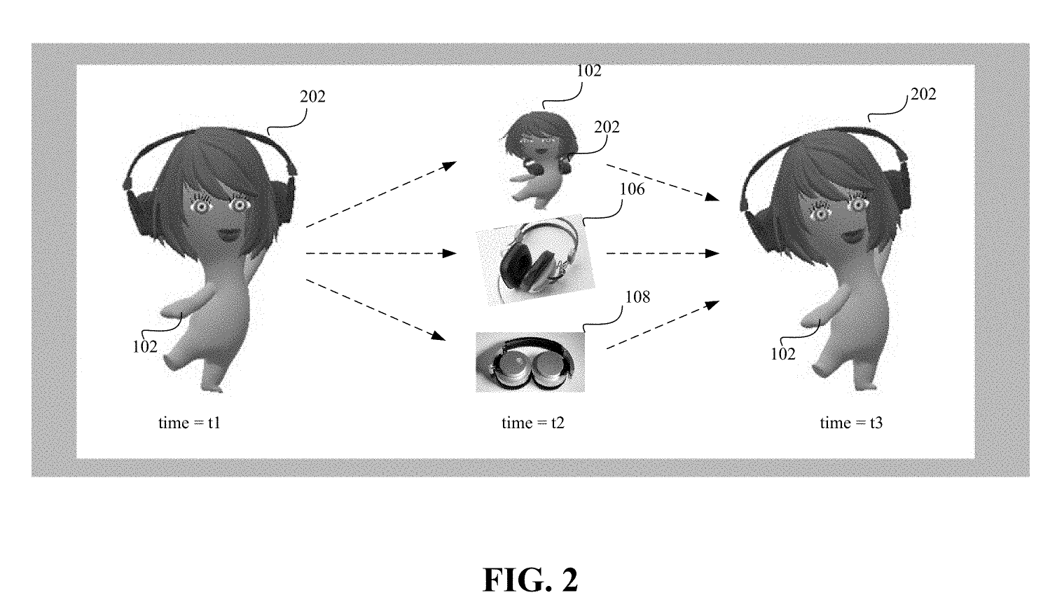

FIG. 2 depicts a scenario where headphones left powered-on by a user are auto-powered down using acoustic detection techniques thereby causing user delight when the user finds the headphone battery still charged according to an embodiment. The user 102 is shown listening to audio, listening on a phone call, or enjoying peace and quiet using her headphones 202 at time t1 in a similar manner as depicted in FIG. 1. The headphones 202 are capable of performing acoustic idle detection according to an embodiment. The audio or noise cancellation plays for several hours before the user 102 removes the headphones 202 from her ears while the headphones 202 are actively streaming content or actively cancelling noise.

At time t2, the user 102 may place the headphones 202 around her neck or place the headphones 202 on a surface in one of the positions identified by 106 and 108 as described above in FIG. 1 at time t2. Again, the user 102 has not powered down the headphones 202 and leaves the headphones 202 unattended for a long period of time. But unlike the scenario of FIG. 1, the headphones 202 are able to actively detect the acoustic signals between the earpieces and automatically power-down when it is determined that the headphones 202 are in an idle state (i.e., not being worn over the ears) according to embodiments. Once it is determined that the headphones 202 are in an idle state for a prolonged period of time, such as, for example, five minutes, the headphones 202 are powered down, causing the user 102 to turn the headphones 202 back on when they use them again. This reduces power consumption, thus preserving the battery life of the headphones 202 when the user 102 is not actually wearing the headphones 202 on her ears. In embodiments, the headphones 202 may use a stateless button to control the power of the headphones 202. Stateless buttons are well known in the relevant art(s). As shown in FIG. 2, the user 102 is very happy when she puts her headphones 202 back over her ears at time t3 and turns her headphones 202 on to find that the batteries in her headphones 202 are not drained, and she can listen to audio, make phone calls, or enjoy peace and quiet without having to recharge the batteries.

Embodiments use acoustic idle detection techniques to listen for specific audio content from one earpiece on the other earpiece in order to make a determination as to whether or not the user is wearing the headphones. Embodiments utilize headphones with built-in microphones and noise cancellation. In embodiments, the headphones eavesdrop the surrounding sounds to detect the audio between the earpieces. Embodiments do not require that both earpieces must be facing each other or that the sound waves are uni-directional. In fact, when the transmitter and receiver are not facing each other, the earpieces may include multiple transceivers having omni-directional transducers that enable the earpieces to pick up surrounding sounds. The transducers may be capable of periodically transmitting inaudible signals, such as, for example, chirps using ultrasounds, or other high frequency inaudible sound waves to better detect when the headphones are not in use when used for noise cancellation only or when audio is played from a single channel, i.e., mono (vs. multiple channels, i.e., stereo).

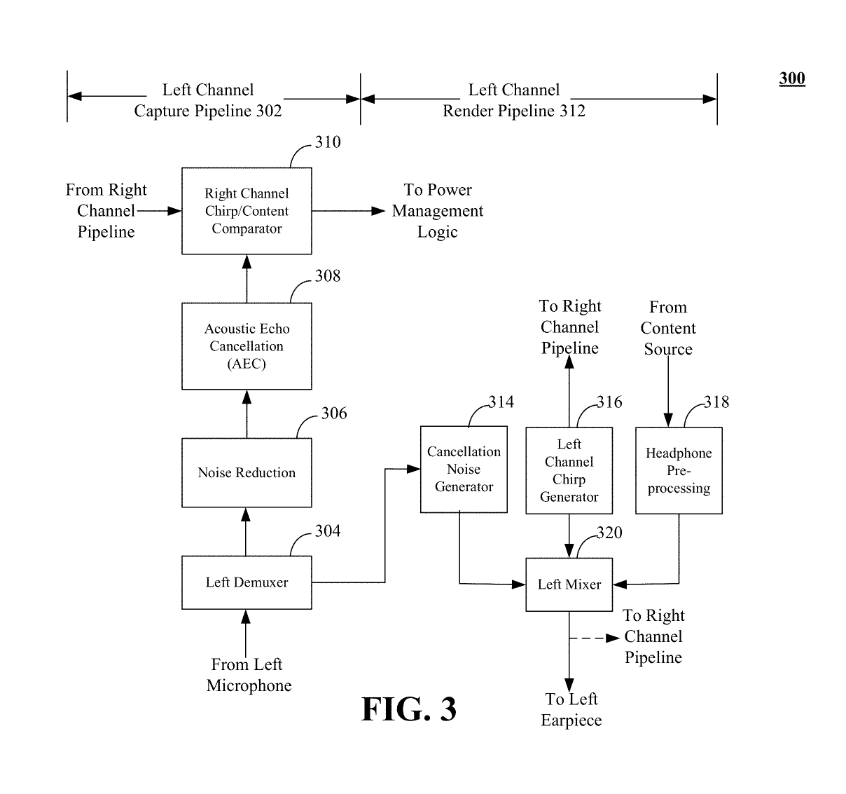

FIG. 3 is a block diagram illustrating an example acoustic processing pipeline 300 of a headphone left earpiece according to an embodiment. The acoustic processing pipeline 300 includes a left channel capture pipeline 302 and a left channel render pipeline 312. The left channel capture pipeline 302 may obtain input from a microphone to capture or record audio. The left channel render pipeline 312 may send output to a speaker to render or play audio. The headphone therefore operates as a microphone using the left channel capture pipeline 302 and a speaker using the left channel render pipeline 312.

The left channel capture pipeline 302 may include a left demuxer 304, a noise reduction 306, an acoustic echo cancellation (AEC) 308, and a right channel chirp/content comparator 310. The left demuxer 304 may be coupled to the noise reduction 306, while the noise reduction 306 may be coupled to the acoustic echo cancellation 308. The acoustic echo cancellation 308 is coupled to the right channel chirp/content comparator 310.

The illustrated left demuxer 304 operates as a splitter. The left demuxer 304 may send input received from the left microphone to the left channel capture pipeline 302 and to the left channel render pipeline 312.

With respect to the left channel capture pipeline 302, the audio signal received from the left microphone may be sent to the noise reduction 306. The noise reduction 306 reduces ambient noise as well as other noises happening in the environment from the audio signal.

The audio signal may then be sent to the acoustic echo canceller (AEC) 308. The acoustic echo canceller 308 is used to cancel the acoustic feedback between the speaker and the microphone. In other words, the AEC 308 may remove from the signal whatever the left earpiece is playing and feeds the remaining signal into the right channel chirp/content comparator 310.

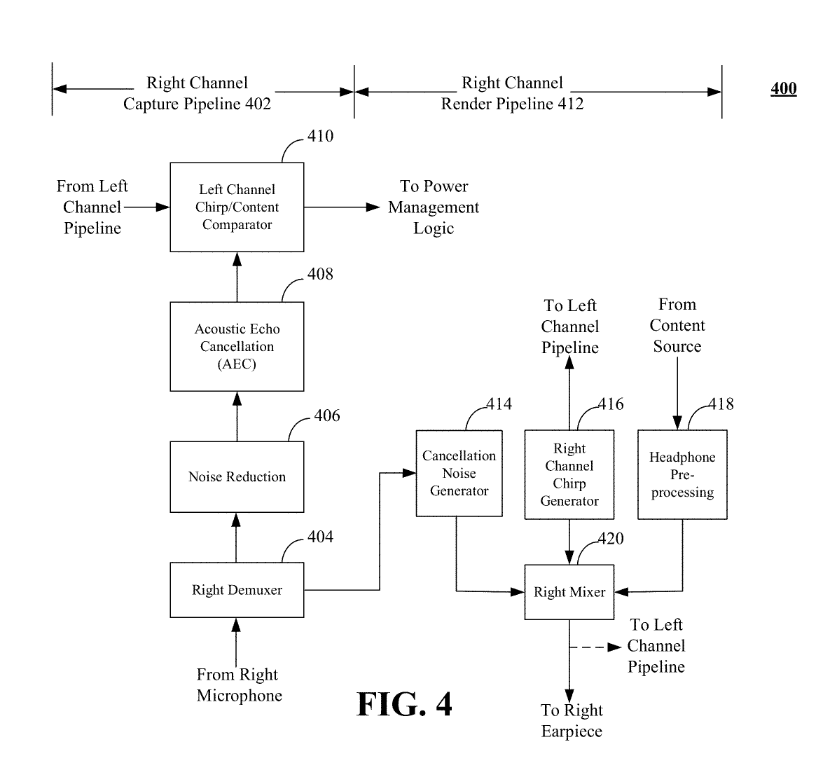

In embodiments, the right channel chirp/content comparator 310 also receives an audio signal from the right channel pipeline (shown below in FIG. 4). In embodiments, the audio signal from the right channel pipeline may be audio playback from a content source plus a chirp signal or only the chirp signal. The right channel chirp/content comparator 310 receives the two audio signals, one from the left microphone and the other from the right channel pipeline (shown in FIG. 4), and compares the two signals. A pre-determined threshold may be used to accommodate for insignificant mismatch caused by signal loss, noise or other causes that contribute to signal attenuation. The pre-determined threshold is determined for each headphone prior to use. The pre-determined threshold may be different for each headphone, depending on the manufacturer and the model of the headphones. In one embodiment, the pre-determined threshold may be fine-tuned based on the characteristics of the headphones and set in the software prior to the product being shipped. In another embodiment, the pre-determined threshold may also be dynamically updated to account for other factors, such as, for example, the user's physical features, type of content, etc. In yet another embodiment, the pre-determined threshold may be customized after purchasing to take into account factors such as, for example, the user's physical features (i.e., head shape, shoulder width, and other physical factors that may impact the way audio travels between headphones), type of content, etc.

If the difference between the two signals is less than or equal to the pre-determined threshold, then a signal is sent to the power management logic to indicate that the power management logic should power-down the headphone because the headphones are not being used. Alternatively, if the difference between the two signals exceeds the pre-determined threshold, this is an indication that the headphones are in use by someone. In this instance, the headphones remain powered-up.

As previously indicated, the left channel render pipeline 312 provides output to a speaker. The left channel render pipeline 312 includes a cancellation noise generator 314, a left channel chirp generator 316, a headphone pre-processor 318, and a left mixer 320. The cancellation noise generator 314 is coupled to the left demuxer 304 of the left channel capture pipeline 302 and to the left mixer 320. The left channel chirp generator 316 is coupled to the left mixer 320. The headphone pre-processor 318 is also coupled to the left mixer 320.

The left channel render pipeline 312 receives the left channel of the content to be rendered. In other words, audio comes out of the left earpiece from the left channel render pipeline 312. The content source is input into the headphone pre-processing logic 318. The content source may be, for example, music, sound from movies, television, video clips, etc., or speech. The pre-processing logic 318 may be used as an option to enhance the content source sound. The output from the pre-processing logic 318 is fed into the left mixer 320. Although not shown, if enhancement of the content source sound is not needed or is not desired, the pre-processing logic 318 may be by-passed. In embodiments where the headphones are used for noise cancellation purposes only, the pre-processing logic 318 may also be by-passed.

The left channel chirp generator 316 is used to generate chirps that may be sent to the right earpiece of the headphone to determine whether or not to power off the headphone. The left channel chirp generator 316 is fed into the left mixer 320.

The cancellation noise generator 314 receives as input the audio signal from the left microphone. The cancellation noise generator 314 cancels the ambient noises coming from the left microphone. It takes the noise from the microphone and plays the opposite signal out of the earpiece so that the user thinks that they do not hear the noise. The output of the cancellation noise generator 314 is fed into the left mixer 320 in order to cancel the noise captured from the left microphone.

The left mixer 320 receives the cancellation noise of the left microphone from the cancellation noise generator 314, the chirps generated from the left channel chirp generator 316, and the rendered content from the headphone pre-processing logic 318 and mixes the signals together for rendering the content to the left earpiece and to the right channel pipeline shown in FIG. 4.

Note that embodiments may operate using the rendered content and the chirp or the chirp alone to drive the power management logic. In one embodiment, only the chirp content is provided to the chirp/content comparator 310. In another embodiment, both the rendered content and the chirp are provided to the chirp/content comparator 310. In one embodiment, the chirp may be generated from the left earpiece and sent to the right earpiece and vice versa.

FIG. 4 illustrates an example acoustic processing pipeline 400 of a headphone right earpiece according to an embodiment. As shown in FIG. 4, the right earpiece is identical to the left earpiece shown in FIG. 3, and operates in a similar manner as indicated above with reference to FIG. 3.

The acoustic processing pipeline 400 includes a right channel capture pipeline 402 and a right channel render pipeline 412. The right channel capture pipeline 402 may obtain input from a right microphone to capture or record audio. The right channel render pipeline 412 may send output to a speaker to render or play audio. This allows the headphones to operate as a microphone using the right channel capture pipeline 402 and a speaker using the right channel render pipeline 412.

The right channel capture pipeline 402 may include a right demuxer 404, a noise reduction 406, an acoustic echo cancellation (AEC) 408, and a left channel chirp/content comparator 410. The right demuxer 404 may be coupled to the noise reduction 406, while the noise reduction 406 may be coupled to the acoustic echo cancellation 408. The acoustic echo cancellation 408 may be coupled to the left channel chirp/content comparator 410.

The right demuxer 404 operates as a splitter. The right demuxer 404 sends input received from the right microphone to the right channel capture pipeline 402 and to the right channel render pipeline 412.

With respect to the right channel capture pipeline 402, the audio signal received from the right microphone is sent to the noise reduction 406. The noise reduction 406 reduces ambient noise as well as other noises happening in the environment from the audio signal.

The audio signal from the noise reduction 406 is sent to the acoustic echo canceller (AEC) 408. The acoustic echo canceller 408 is used to cancel the acoustic feedback between the speaker and the microphone. In other words, the AEC 408 removes from the signal whatever the right earpiece is playing and feeds the signal into the left channel chirp/content comparator 410.

In embodiments, the left channel chirp/content comparator 410 also receives an audio signal from the left channel pipeline (shown above in FIG. 3). In embodiments, the audio signal from the left channel pipeline may be audio playback from a content source plus a chirp signal or only the chirp signal. The left channel chirp/content comparator 410 receives the two audio signals, one from the right microphone and the other from the left channel pipeline (shown in FIG. 3), and compares the two signals. As previously indicated, a pre-determined threshold may be used to accommodate for insignificant mismatch caused by signal loss, noise or other causes that contribute to signal attenuation. The pre-determined threshold is determined for each headphone prior to use. The pre-determined threshold may be different for each headphone, depending on the manufacturer and the model of the headphones. In one embodiment, the pre-determined threshold may be fine-tuned based on the characteristics of the headphones and set in the software prior to the product being shipped. In another embodiment, the pre-determined threshold may also be dynamically updated to account for other factors, such as, for example, the user's physical features, typical type of content, etc. If the difference between the two signals is less than or equal to the pre-determined threshold, then a signal is sent to the power management logic to indicate that the power management logic should power-down the headphone because the headphones are not being used. Alternatively, if the difference between the two signals exceeds the pre-determined threshold, this is an indication that the headphones are in use by someone. In this instance, the headphones remain powered-up.

As previously indicated, the right channel render pipeline 412 provides output to a speaker. The right channel render pipeline 412 includes a cancellation noise generator 414, a right channel chirp generator 416, a headphone pre-processor 418, and a right mixer 420. The cancellation noise generator 414 is coupled to the right demuxer 404 of the right channel capture pipeline 402 and to the right mixer 420. The right channel chirp generator 416 is coupled to the right mixer 420. The headphone pre-processor 418 is also coupled to the right mixer 420.

The right channel render pipeline 412 receives the right channel of the content to be rendered. In other words, audio comes out of the right earpiece from the right channel render pipeline 412. The content source is input into the headphone pre-processing logic 418. The content source may be, for example, music, sound from movies, television, video clips, etc., or speech. The pre-processing logic 418 may be used as an option to enhance the content source sound. The output from the pre-processing logic 418 is fed into the right mixer 420. Although not shown, if enhancement of the content source sound is not needed or is not desired, the pre-processing logic 418 may be by-passed. In embodiments where the headphones are used for noise cancellation purposes only, the pre-processing logic 418 may also be by-passed.

The right channel chirp generator 416 is used to generate chirps that may be sent to the left earpiece of the headphone to determine whether or not to power off the headphones. The right channel chirp generator 416 is fed into the right mixer 420.

The cancellation noise generator 414 receives as input the audio signal from the right microphone. The cancellation noise generator 414 cancels the ambient noises coming from the right microphone. It takes the noise from the microphone and plays the opposite signal out of the earpiece so that the user thinks that they do not hear the noise. The output of the cancellation noise generator 414 is fed into the right mixer 420 in order to cancel the noise captured from the right microphone.

The right mixer 420 receives the cancellation noise of the right microphone from the cancellation noise generator 414, the chirps generated from the right channel chirp generator 416, and the rendered content from the headphone pre-processing logic 418 and mixes the signals together for rendering the content to the right earpiece and to the left channel pipeline shown in FIG. 3.

Note again that embodiments may operate using the rendered content and the chirp or the chirp alone to drive the power management logic. In one embodiment, only the chirp content is provided to the chirp/content comparator 410. In another embodiment, both the rendered content and the chirp are provided to the chirp/content comparator 410.

Although embodiments have been described where both earpieces of the headphones are capable of performing acoustic idle detection, embodiments are not limited to the right and left earpieces being symmetrical. In one embodiment, the earpieces may be asymmetrical, thus allowing for only one earpiece of the headphones to perform acoustic idle detection.

Note that FIGS. 3 and 4 are only example representations of pipelines for left and right earpieces of headphones. One skilled in the relevant art(s) would know that other pipelines may be used.

In embodiments, power is also preserved by performing the acoustic detection as described above periodically to determine whether the headphones should be powered down. For example, in one embodiment, the acoustic signals from the earpieces of the headphones are sampled and compared once every minute. Sampling and comparing too frequently may lead to more power consumption instead of preserving power.

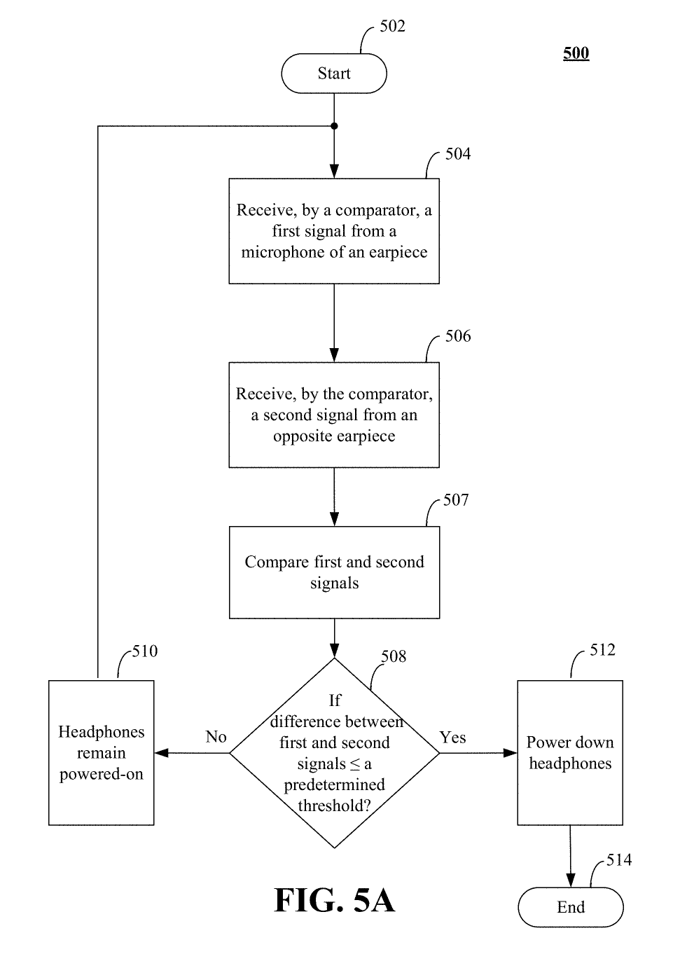

FIG. 5A illustrates a flow diagram of an example method 500 for managing the on/off state of a headphone according to an embodiment. The method 500 may generally be implemented in headphones such as, for example, the headphones as shown in FIGS. 2, 3, and 4. More particularly, the method 500 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), and fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 500 may be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instruction, instruction set architecture (ISA) instructions, machine instruction, machine depended instruction, microcode, state setting data, configuration data for integrated circuitry, state information that personalizes electronic circuitry and/or other structural components that are native to hardware (e.g., host processor, central processing unit (CPU), microcontroller, etc.).

The process begins in block 502, where the process immediately proceeds to block 504.

In block 504, a chirp/content comparator receives a first signal from a microphone of a first earpiece. The first earpiece is part of a headphone. The first signal from the microphone of the first earpiece has been passed through a noise reduction and acoustic echo cancellation to isolate the microphone signal such that an identifying signal from the opposite earpiece can be detected by the chirp/content detector. The process proceeds to block 506.

In block 506, a second signal is received from the opposite earpiece of the headphones. The second signal may be a chirp from the opposite earpiece or a combination of the chirp and source content from the opposite earpiece. The process then proceeds to block 507.

In block 507, the chirp/content comparator compares the first signal to the second signal. The process then proceeds to decision block 508.

In decision block 508, if the difference between the first and second signals is less than or equal to a pre-determined threshold, the process proceeds to block 512.

In block 512, a signal is sent to the power management logic to enable the power management logic to power down the headphones. The process then proceeds to block 514, where the process ends.

Returning to decision block 508, if the difference between the first and second signals is greater than the pre-determined threshold, the process proceeds to block 510, where the headphones remain powered on. The process then proceeds back to block 504 to periodically repeat the process of determining whether the headphones are being used. As previously indicated, the process may repeat once every minute. In other embodiments the process may repeat once every 5 minutes or at a different time interval to be determined by the user.

Embodiments are intended for use with headphones that have built-in microphones. Furthermore, embodiments are intended for headphones having noise cancellation capabilities. Thus, the headphones may operate in noise cancellation only mode or in audio playback with noise cancellation mode. When in audio playback with noise cancellation mode, the process for single channel audio (i.e., mono) is different than multiple channel audio (i.e., stereo). This is to avoid the risk of the acoustic echo cancellation, performed on the signal captured from the microphone, removing the microphone audio signal from the signal being fed into the chirp/content comparator on the capture pipeline side since the microphone signal is identical to the signal being rendered or played out of the same earpiece. Although not explicitly shown, the headphones include a processor that knows whether the audio being played is in mono or stereo.

FIG. 5B is a flow diagram of an example of a method 515 for using acoustic detection techniques to determine if a user is wearing headphones according to an embodiment. The method 515 may generally be implemented in headphones such as, for example, the headphones shown in FIGS. 3, 4A, and 4B. More particularly, the method 515 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, and fixed-functionality logic hardware using circuit technology such as, for example, ASIC, CMOS or TTL technology, or any combination thereof

The process begins in block 520, where the process immediately proceeds to decision block 522. In decision block 522, it is determined whether audio is playing. If audio is playing, the process proceeds to decision block 524.

In decision block 524, it is determined whether the audio is stereo or mono. If the audio is stereo, the process proceeds to block 526.

In block 526, both earpieces listen for a signal that matches the opposite earpiece. The process then proceeds to decision block 528.

In decision block 528, it is determined whether a matching signal has been found. If the difference between the signals from the earpieces is less than or equal to a predetermined threshold, the signal is characterized as matching. If a matching signal has been found, the process proceeds to block 530, where it is determined that the headphones are not being used and are powered-down.

Returning to decision block 528, if a matching signal has not been found (i.e., the resulting signal is greater than the predetermined threshold), the process proceeds to block 532, where it is determined that the headphones are being used. In this instance, the headphones remain powered-on.

Returning to decision block 522, if audio is not being played and the headphones are operating in noise cancellation mode only, the process proceeds to block 534. In block 534, the right or the left earpiece may periodically send a high frequency chirp signal. The process then proceeds to decision block 536.

In decision block 536, it is determined whether the difference between the signal received, or bounced, back from the opposite earpiece, or from another object, and the signal sent is less than or equal to a pre-determined threshold level. As previously indicated, the pre-determined threshold level may vary depending on the model and make of the headphones and other factors, and therefore, is determined prior to its use. If the difference between the signal received and the signal sent is less than or equal to the pre-determined threshold level, the process proceeds to block 540. In block 540, the headphones are not being used and are powered-down.

Returning to decision block 536, if the difference between the receiving signal and the sent signal is greater than the predetermined threshold level, the process proceeds to block 538. In block 538, the headphones are being used and remain powered-on.

Returning to decision block 524, if it is determined that the audio is being played in mono or a single channel, the process proceeds to block 534 as described above. In other words, if the audio is being played on a single channel, the process is identical to the process for noise cancellation mode only shown in blocks 534-540.

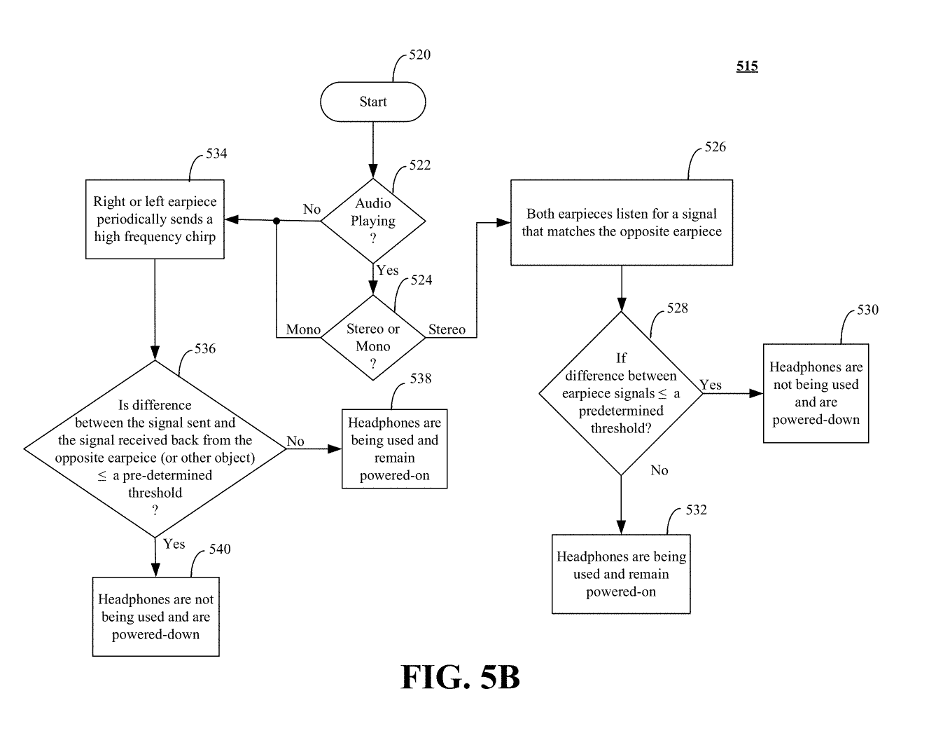

FIG. 6 is a block diagram of an example of an acoustic idle detection headphone system to extend battery life of headphones according to an embodiment. The illustrated system 600 includes a processor 602 (e.g., host processor, central processing unit/CPU) having acoustic idle detection logic 604 and an integrated memory controller (IMC) 606 coupled to system memory 610 (e.g., volatile memory, dynamic random-access memory (DRAM). The processor 602 may include a core region with one or more processor cores (not shown). The processor 602 may also be coupled to an input/output (I/O) module 608 that communicates with network interface circuitry 616 (e.g., network controller, network interface card/NIC) and mass storage 614 (non-volatile memory/NVM, hard disk drive/HDD, optical disk, solid state disk/SSD, flash memory). The network interface circuitry 616 may provide communication functionality, such as, for example, cellular telephone (e.g., Wideband Code Division Multiple Access/W-CDMA (Universal Mobile Telecommunications System/UMTS), CDMA2000 (IS-856/IS-2000), etc.), WiFi (Wireless Fidelity, e.g., Institute of Electrical and Electronics Engineers/IEEE 802.11-2007, Wireless Local Area Network/LAN Medium Access Control (MAC) and Physical Layer (PHY) Specifications), Bluetooth, and other standards and/or communication technologies. The I/O module 608 may also be coupled to a left earpiece 618 and a right earpiece 620. Each earpiece 618 and 620 includes capture and render pipelines (CPL and RPL) as described above with reference to FIGS. 3 and 4. Although not shown above with respect to FIGS. 3 and 4, each earpiece 618 and 620 includes a microphone and a speaker. The system 600 also includes a battery 622.

The acoustic idle detection logic 604 may be in the form of logic instructions, configurable logic, fixed-functionality hardware logic, etc., or any combination thereof. The acoustic idle detection logic 604 is used to preserve the battery 622 when the headphones are left idle with the power in an ON state. The timing logic 604a determines how often the system 600 should check the headphones for idleness. The comparator logic 604b periodically (based on the timing logic) receives signals from both earpieces and determines whether the signals match within a pre-determined threshold. The power management logic 604c may shut down the power based on the results of the comparison logic 604b. Although the illustrated acoustic idle detection logic 604 is shown as being implemented on the processor 602, one or more aspects of the acoustic idle detection logic 604 may be implemented on the earpieces 618 and/or 620.

The system memory 610 and/or the mass storage 614 may be memory devices that store instructions 612, which when executed by the processor 602, cause the system 600 to perform one or more aspects of the methods 500 (FIG. 5A) and 515 (FIG. 5B), already discussed. Thus, execution of the instructions 612 may cause the system 600 to receive, by a comparator, a first acoustic signal from a first earpiece of the headphones; receive, by the comparator, a second acoustic signal from a second earpiece of the headphones; compare the first and second acoustic signals; and if the first and second acoustic signals match within a pre-determined threshold, signal power management logic of the headphones to power-down the headphones.

Although the processor 602 and the I/O module 608 are illustrated as separate blocks, the processor 602 and the I/O module 608 may be implemented as a system on chip (SoC) on the same semiconductor die. The processor 602 and the IO module 608 may be incorporated into a shared die 616 as a system on chip (SoC).

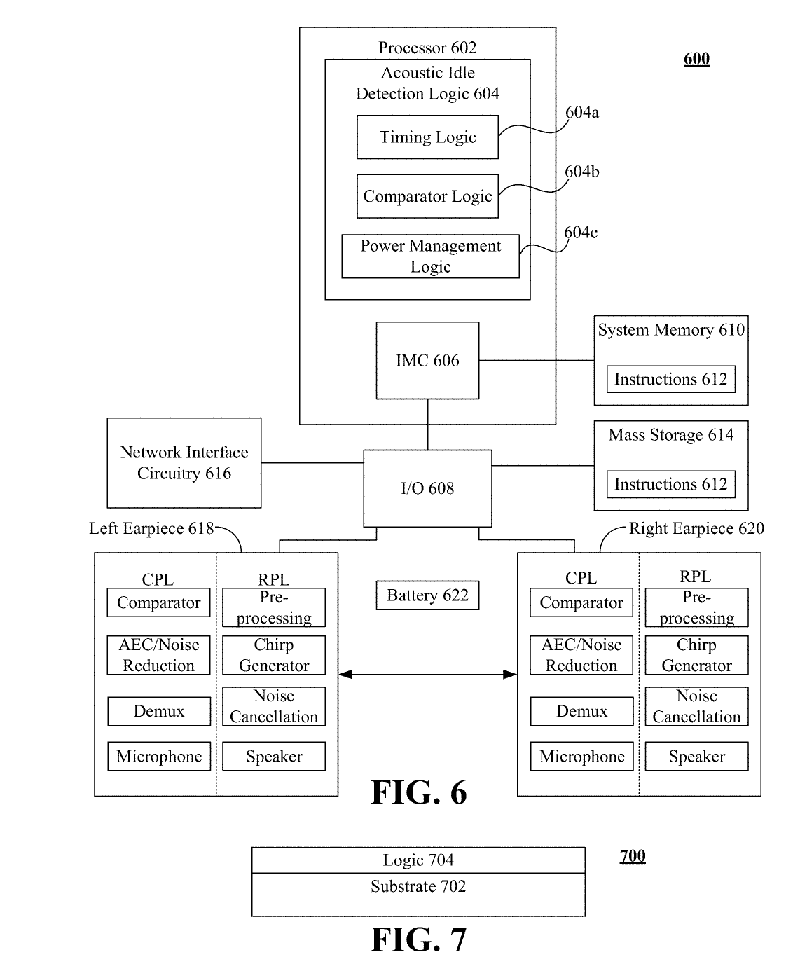

FIG. 7 shows a semiconductor package apparatus 700 (e.g., chip) that includes a substrate 702 (e.g., silicon, sapphire, gallium arsenide) and logic 704 (e.g., transistor array and other integrated circuit/IC components) coupled to the substrate 702. The logic 704, which may be implemented in configurable logic and/or fixed-functionality logic hardware, may generally implement one or more aspects of the method 500 (FIG. 5A) and the method 515 (FIG. 5B), already discussed. In one example, the logic 704 includes transistor channel regions that are positioned (e.g., embedded) within the substrate(s) 702. Thus, the interface between the logic 704 and the substrate(s) 702 may not be an abrupt junction. The logic 704 may also be considered to include an epitaxial layer that is grown on an initial wafer of the substrate(s) 702.

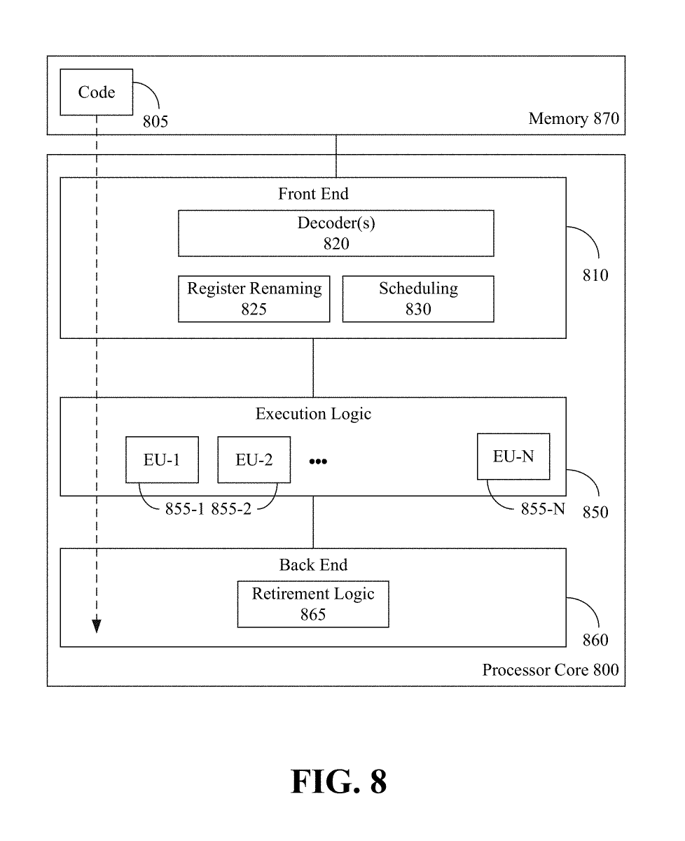

FIG. 8 illustrates a processor core 800 according to one embodiment. The processor core 800 may be the core for any type of processor, such as a micro-processor, an embedded processor, a digital signal processor (DSP), a network processor, or other device to execute code. Although only one processor core 800 is illustrated in FIG. 8, a processing element may alternatively include more than one of the processor core 800 illustrated in FIG. 8. The processor core 800 may be a single-threaded core or, for at least one embodiment, the processor core 800 may be multithreaded in that it may include more than one hardware thread context (or “logical processor”) per core.

FIG. 8 also illustrates a memory 870 coupled to the processor core 800. The memory 870 may be any of a wide variety of memories (including various layers of memory hierarchy) as are known or otherwise available to those of skill in the art. The memory 870 may include one or more code 805 instruction(s) to be executed by the processor core 800, wherein the code 805 may implement the methods 500 (FIG. 5A) and 515 (FIG. 5B), already discussed. The processor core 800 follows a program sequence of instructions indicated by the code 805. Each instruction may enter a front end portion 810 and be processed by one or more decoders 820. The decoder 820 may generate as its output a micro operation such as a fixed width micro operation in a predefined format, or may generate other instructions, microinstructions, or control signals which reflect the original code instruction. The illustrated front end portion 810 also includes register renaming logic 825 and scheduling logic 830, which generally allocate resources and queue the operation corresponding to the convert instruction for execution.

The processor core 800 is shown including execution logic 850 having a set of execution units 855-1 through 855-N. Some embodiments may include a number of execution units dedicated to specific functions or sets of functions. Other embodiments may include only one execution unit or one execution unit that can perform a particular function. The illustrated execution logic 850 performs the operations specified by code instructions.

After completion of execution of the operations specified by the code instructions, back end logic 860 retires the instructions of the code 805. In one embodiment, the processor core 800 allows out of order execution but requires in order retirement of instructions. Retirement logic 865 may take a variety of forms as known to those of skill in the art (e.g., re-order buffers or the like). In this manner, the processor core 800 is transformed during execution of the code 805, at least in terms of the output generated by the decoder, the hardware registers and tables utilized by the register renaming logic 825, and any registers (not shown) modified by the execution logic 850.

Although not illustrated in FIG. 8, a processing element may include other elements on chip with the processor core 800. For example, a processing element may include memory control logic along with the processor core 800. The processing element may include I/O control logic and/or may include I/O control logic integrated with memory control logic. The processing element may also include one or more caches.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

As used in this application and in the claims, a list of items joined by the term “one or more of” may mean any combination of the listed terms. For example, the phrases “one or more of A, B or C” may mean A; B; C; A and B; A and C; B and C; or A, B and C.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device). As used herein, the term “logic” and “module” may refer to, be part of, or include an application specific integrated circuit (ASIC), an electronic circuit, a processor (shared, dedicated, or group), and/or memory (shared, dedicated, or group) that execute one or more software or firmware programs having machine instructions (generated from an assembler and/or a compiler), a combinational logic circuit, and/or other suitable components that provide the described functionality.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. An acoustic idleness detection system for headphones comprising:
a comparator to receive a first acoustic signal from a first earpiece of the headphones and a second acoustic signal from a second earpiece of the headphones and to compare the first and second acoustic signals;
a processor; and
one or more memory devices coupled to the processor, the one or more memory devices including instructions, which when executed by the processor, cause the system to:
determine if the first and second acoustic signals match within a pre-determined threshold; and
signal power management logic of the headphones to power-down the headphones if the signals match.

2. The acoustic idleness detection system of claim 1, wherein the first acoustic signal is received from a microphone of a capture pipeline of the first earpiece, wherein the first acoustic signal is passed through a noise reduction and an acoustic echo cancellation to isolate the first acoustic signal prior to being received by the comparator.

3. The acoustic idleness detection system of claim 1, wherein the second acoustic signal is received from a render pipeline of the second earpiece through a speaker of the headphones.

4. The acoustic idleness detection system of claim 1, wherein if the headphones are powered-on in audio mode with noise cancellation and the audio is playing in stereo, the second acoustic signal comprises cancellation noise mixed with rendered content, wherein comparing the first and second acoustic signals comprises listening, by both first and second earpieces, for a signal that matches from the opposite earpiece.

5. The acoustic idleness detection system of claim 1, wherein if the headphones are powered-on in audio mode with noise cancellation and the audio is playing in mono, the second acoustic signal comprises an inaudible frequency pattern, wherein comparing the first and second acoustic signals comprises comparing the inaudible frequency pattern signal received, or bounced, back from the opposite earpiece.

6. The acoustic idleness detection system of claim 1, wherein if the headphones are powered-on in noise cancellation mode only, the second acoustic signal comprises an inaudible frequency pattern, wherein comparing the first and second acoustic signals comprises comparing the inaudible frequency pattern signal received, or bounced, back from the opposite earpiece.

7. A headphone apparatus comprising:
one or more substrates;
logic coupled to the one or more substrates, wherein the logic includes one or more of configurable logic or fixed-functionality hardware logic, the logic coupled to the one or more substrates to:
receive, by a comparator, a first acoustic signal from a first earpiece of the headphones;
receive, by the comparator, a second acoustic signal from a second earpiece of the headphones;
compare the first and second acoustic signals; and
if the first and second acoustic signals match within a pre-determined threshold, signal power management logic of the headphones to power-down the headphones.

8. The headphone apparatus of claim 7, wherein the first acoustic signal is received from a microphone of a capture pipeline of the first earpiece, wherein the first acoustic signal is passed through a noise reduction and an acoustic echo cancellation to isolate the first acoustic signal prior to being received by the comparator.

9. The headphone apparatus of claim 7, wherein the second acoustic signal is received from a render pipeline of the second earpiece through a speaker of the headphones.

10. The headphone apparatus of claim 7, wherein if the headphones are powered-on in audio mode with noise cancellation and the audio is playing in stereo, the second acoustic signal comprises cancellation noise mixed with rendered content and an inaudible frequency pattern, wherein comparing the first and second acoustic signals comprises listening, by both first and second earpieces, for a signal that matches from the opposite earpiece.

11. The headphone apparatus of claim 7, wherein if the headphones are powered-on in audio mode with noise cancellation and the audio is playing in mono, the second acoustic signal comprises an inaudible frequency pattern, wherein comparing the first and second acoustic signals comprises comparing the inaudible frequency pattern signal received, or bounced, back from the opposite earpiece.

12. The headphone apparatus of claim 7, wherein if the headphones are powered-on in noise cancellation mode only, the second acoustic signal comprises an inaudible frequency pattern, wherein comparing the first and second acoustic signals comprises comparing the inaudible frequency pattern signal received, or bounced, back from the opposite earpiece.

13. An acoustic method of determining idleness in headphones comprising:
receiving, by a comparator, a first acoustic signal from a first earpiece of the headphones;
receiving, by the comparator, a second acoustic signal from a second earpiece of the headphones;
comparing the first and second acoustic signals; and
if the first and second acoustic signals match within a pre-determined threshold, signaling power management logic of the headphones to power-down the headphones.

14. The method of claim 13, wherein the first acoustic signal is received from a microphone of a capture pipeline of the first earpiece, wherein the first acoustic signal is passed through a noise reduction and an acoustic echo cancellation to isolate the first acoustic signal prior to being received by the comparator.

15. The method of claim 13, wherein the second acoustic signal is received from a render pipeline of the second earpiece through a speaker of the headphones.

16. The method of claim 13, wherein if the headphones are powered-on in audio mode with noise cancellation and the audio is playing in stereo, the second acoustic signal comprises cancellation noise mixed with rendered content, wherein comparing the first and second acoustic signals comprises listening, by both first and second earpieces, for a signal that matches from the opposite earpiece.

17. The method of claim 13, wherein if the headphones are powered-on in audio mode with noise cancellation and the audio is playing in mono, the second acoustic signal comprises an inaudible frequency pattern, wherein comparing the first and second acoustic signals comprises comparing the inaudible frequency pattern signal received, or bounced, back from the opposite earpiece.

18. The method of claim 13, wherein if the headphones are powered-on in noise cancellation mode only, the second acoustic signal comprises an inaudible frequency pattern, wherein comparing the first and second acoustic signals comprises comparing the inaudible frequency pattern signal received, or bounced, back from the opposite earpiece.

19. The method of claim 13, wherein if the first and second signals do not match within a pre-determined threshold, signaling the power management logic to continue powering the headphones.

20. At least one computer readable medium, comprising a set of instructions, which when executed by a computing device, cause the computing device to:
receive, by a comparator, a first acoustic signal from a first earpiece of the headphones;
receive, by the comparator, a second acoustic signal from a second earpiece of the headphones;
compare the first and second acoustic signals; and
if the first and second acoustic signals match within a pre-determined threshold, signal power management logic of the headphones to power-down the headphones.

21. The at least one computer readable medium of claim 20, wherein the first acoustic signal is received from a microphone of a capture pipeline of the first earpiece, wherein the first acoustic signal is passed through a noise reduction and an acoustic echo cancellation to isolate the first acoustic signal prior to being received by the comparator.

22. The at least one computer readable medium of claim 20, wherein the second acoustic signal is received from a render pipeline of the second earpiece through a speaker of the headphones.

23. The at least one computer readable medium of claim 20, wherein if the headphones are powered-on in audio mode with noise cancellation and the audio is playing in stereo, the second acoustic signal comprises cancellation noise mixed with rendered content, wherein comparing the first and second acoustic signals comprises listening, by both first and second earpieces, for a signal that matches from the opposite earpiece.

24. The at least one computer readable medium of claim 20, wherein if the headphones are powered-on in audio mode with noise cancellation and the audio is playing in mono, the second acoustic signal comprises an inaudible frequency pattern, wherein comparing the first and second acoustic signals comprises comparing the inaudible frequency pattern signal received, or bounced, back from the opposite earpiece.

25. The at least one computer readable medium of claim 20, wherein if the headphones are powered-on in noise cancellation mode only, the second acoustic signal comprises an inaudible frequency pattern, wherein comparing the first and second acoustic signals comprises comparing the inaudible frequency pattern signal received, or bounced, back from the opposite earpiece.
